(19) United States
(12) Patent Application Publication
(10) Pub. No.: US 2004/0105913 A1
(43) Pub. Date: Jun. 3, 2004

(54) Process for the supplementation in constituents of an alcoholic beverage and application particularly to the production of red wine in a container

(75) Inventor: Jean-Francois Laffort, Bordeaux (FR)

Correspondence Address: YOUNG & THOMPSON, 745 SOUTH 23RD STREET 2ND FLOOR, ARLINGTON, VA, 22202

(73) Assignee: LAFFORT OENOLOGIE, BORDEAUX (FR)

(21) Appl. No.: 10/721,281

(22) Filed: Nov. 26, 2003

(30) Foreign Application Priority Data
Nov. 28, 2002 (FR) 0214969

(51) Int. Cl. C12C 11/00

(52) U.S. Cl. 426/11

(57) ABSTRACT

The object of the invention is a process for supplementing an alcoholic beverage with constituents, during its production, in which, when said beverage is in a production container, carrying out an addition to said beverage of said constituents, characterized in that said addition is carried out with a dosage of constituents predetermined as a function of the difference, measured or estimated, of the content in said constituents between a barrel of new wood of the best essence and said production container and in that the supplemental additions are carried out at predetermined intervals and with dosages predetermined as a function of the nature of said container, so as to compensate over the course of time the decrease by degradation of said constituents and to obtain a curve of concentration in constituents in said beverage tending toward that which would be obtained with said barrel of the best essence instead and in place of said container.

The present invention relates to the development of alcoholic beverages and more particularly to the supplementation in certain constituents of said beverages in the course of their development and particularly although not exclusively to the supplementation in various constituents, for example in tannins, of a red wine during its production in a container.

It is in this application to the production of a red wine, that the invention will be described hereafter, but it is evident that the process of the invention could be applied more generally to the vinification of a must, to the production of brandies such as cognac for example, or else to the production of beer.

It is known that holding a wine, a must, an alcoholic beverage in a wooden container and particularly in a barrel, permits the latter to take up little by little a certain number of constituents of the wood by the phenomena of diffusion.

At the same time, there take place, thanks to the porosity of the barrel, the phenomena of controlled oxidation of the wine and of the constituents given up by the barrel.

The contributed constituents vary of course as a function of the origin of the wood, as a function of the burning of the barrel staves.

All these phenomena are well known.

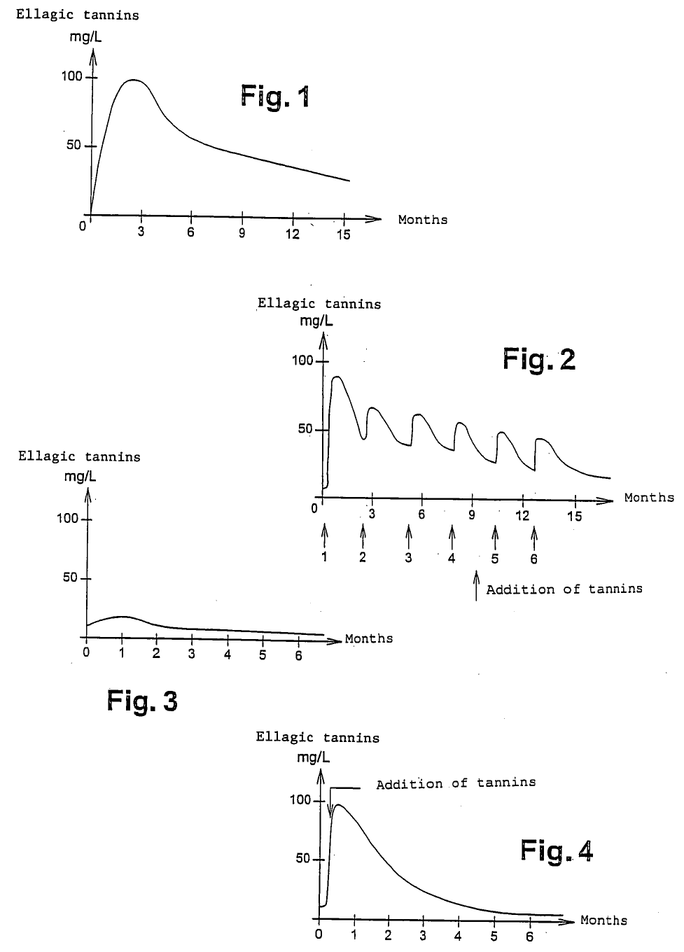

By way of example, there is shown in the accompanying FIG. 1 the development of ellagic tannins contributed by a barrel of French oak in the course of production of a wine. It will be seen that at first, the quantity of ellagic tannins can rise to a concentration comprised between 50 and 150 mg/L in the wine as a function of the nature of the wood used and of the intensity of its heating. Thereafter, to the extent that the wood is depleted in ellagic tannins, the phenomena of hydrolysis and oxidation giving rise to the degradation of these tannins become more important than their dissolution in the wine, which gives rise to a continuous decrease of their concentration in the wine, as can be seen from the curve of FIG. 1.

The production of wines or alcoholic beverages can take place in new barrels but also in containers of wood that are more or less used and which to the extent of their use will be impoverished in constituents adapted to be given up to the liquid and particularly in ellagic tannin. Thus, a production of four months in new barrels of French oak permits having a total quantity of ellagitanins in the wine approach 100 mg/L, whilst the same duration of production in a used barrel permits only having a quantity less than 30 mg/L.

On the other hand, it is also true that wood from certain locations are only less susceptible to give up certain ellagic tannins to the wine. Thus the barrels from American oak are much more impoverished in ellagic tannins than those from French oak because of their botanical origin.

The object of this invention is to overcome the poverty in certain constituents and particularly in tannins, of certain containers, either because they are not of wood, or because they are containers of used wood or are impoverished by their nature, so as to have, for example, in red wine, a quantity of certain desired constituents such that the ellagic tannins, according to a concentration substantially analogous to that which they would have if they were produced during the same period of time in a barrel of new wood of the best essence.

To this end, the invention has for its object a process for the supplementation in constituents, of an alcoholic beverage, during its development, in which, during the emplacement of said beverage in a development container, there is carried out an addition to said beverage of said constituents, characterized in that the addition is carried out with a dose of constituents predetermined as a function of the difference measured or estimated, of the quantity of said constituents between a barrel of new wood of the best essence and said development container and in that the supplemental additions are carried out at predetermined intervals and with predetermined dosages as a function of the nature of said container, so as to compensate in the course of time the decrease by degradation of said constituents and to obtain a curve of concentration of constituents of said beverage tending toward that which would be attained with said barrel of the best essence instead of said container.

An application of the above process to the production of a red wine to be supplemented in tannins will now be described with reference to FIG. 2, which shows the curve of development of the ellagic tannins during production of a red wine under the conditions of the invention, and to FIGS. 3 and 4 which show respectively the development of the concentration in ellagic tannins of a red wine produced in a used barrel and without tannin content (FIG. 3) and the development of the concentration in ellagic tannins of a red wine produced in a used barrel with tannin content a single time (FIG. 4).

It is already known, during vinification of a must or production of a wine, to add to the must or wine vat oenological products that can be constituted by tannin, as described in FR 2 746 812.

However, it is a matter of an initial and single quantity which is never of a nature to overcome the drawbacks pointed out above of the use of containers of used wood or which is impoverished by its nature, or of containers which are not of wood.

Thus, if there were added, for example one time, a large dose of ellagic tannin at the outset in a used barrel, little adapted to contribute itself ellagic tannins, the latter would be hydrolyzed and oxidized at the beginning of several months and the provided oxidation of the ellagic tannins in the course of time would not take place thereafter as in a new barrel. FIG. 4 shows precisely the effects of such an addition in a used barrel and the comparison with FIG. 1 permits seeing in a satisfactory manner the very great difference of concentration in tannins at the beginning of three months of production.

On the other hand, the one-time addition of ellagic tannin leads to less subtle wines, less rounded, than can be obtained by a fractional addition in the course of time according to the teachings of the invention.

According to the invention, one proceeds to the usual refilling of barrels for example used barrels, then there is introduced by means of a dosage pre-calculated for one barrel (tablet, small dose, powder or pre-weighed granules) the tannin or tannins desired as a function of the nature of the container. It can be a matter of various tannins, for example an ellagic tannin, a proanthocyanidic tannin, a gallic or a mixture of various tannins. To this end, the use of a powder or effervescent granules or of a tablet of effervescent tannin or tannins will greatly facilitate the homogenization and the dissolution of the product in the barrel whilst rendering the operation more practical. It is this form that will be preferentially practiced.

By way of non-limiting example, an assembly of potassium bicarbonate 38%, citric acid 21% and ellagic tannin 41% gives very good results in practice.

The initial dose of tannin or tannins added to compensate the deficit of the container should be carried out as a function of the measured or estimated difference of the container relative to a new barrel of the best essence. For this, several manners of proceeding can be used:

dosage of total ellagitanins by HPLC or by a chemical method,

observation of the organoleptic characteristics of the liquid,

empirical estimation of the quantity to be added, given for example that a used barrel having already contained a wine will not give up but at most a quantity of the order of 30 mg/L of ellagitanin, it then being necessary to add a dose between 50 and 80 mg/L of ellagitanin to correspond to the production in a new barrel.

The unit mg/L used in the present invention means milligrams per liter of treated must.

Thereafter, and at a frequency which can be for example monthly or bimonthly, there will be added to each barrel, with preparation such as described above, a pre-calculated quantity of tannin or tannins to simulate the quantity which there would naturally have been in a new barrel, particularly a barrel of wood of the best essence.

This quantity in the course of time will thus permit compensating the decrease by oxidative degradation of the tannins (of the order of 10 to 20 mg/L/month) to maintain it at the same level as a new barrel. This quantity will be less important toward the end of production (of the order of 5 to 10 mg/L/month) to better simulate what would take place for example in a new barrel of French oak, which is to say an extraction of the wood as to substances soluble in the liquid, giving rise to a quantity of ellagic tannins which is smaller and smaller. There will thus be a development for example of the ellagic tannins present as shown in FIG. 2.

In FIG. 2, there is shown at 1 the first quantity of tannin or tannins during placing the wine in the production barrel, and at 2, 3, 4, 5 and 6, the supplementary quantities added at intervals of one or two months, the first supplementary quantity (N° 2) being carried out after three months (or if desired four) of time in the barrel.

The peaks corresponding to quantities Nos. 2 to 6 are progressively less high, corresponding to the progressive reduction of the doses indicated above.

The curve of change of the concentration of tannin or tannins over the course of the months can of course be substantially modified by acting on the successive doses and on the time of their introduction into the barrel.

The process of the invention thus permits obtaining a curve of change of concentration in tannins, particularly in ellagitanins, which tends toward that obtained with a new barrel of French oak (FIG. 1).

FIG. 3 shows what would have been obtained with a barrel of used wood- and without the addition of tannin. From the outset, the concentration for example in ellagitanins is very low and continuously degrades.

In the case of FIG. 4 (used barrel with initial and single addition of ellagitanins) at the beginning of three months of production there is the same amount of concentration as in the case of FIG. 3, whilst with the process of the invention, at the beginning of 12 months there can be a concentration in ellagitanins that can approach 50 mg/L as in the case of a new barrel of the best essence (FIG. 1).

When the added doses (Nos. 2 to 6) are a mixture of different tannins (ellagic tannins, proanthocyanidic tannins, gallic tannins, . . . ), the dose to be added will be pro rated according to the content in ellagic tannin of the initial addition (No. 1). That is to say, if the mixture of tannins contains 50% of ellagic tannins, the predetermined doses will be multiplied by 2, similarly if it were a mixture of ellagic tannin with all the other products (chemicals, organic materials, mineral materials, . . . ).

The invention is of course applicable to the production of a red wine in a container which is not of wood, for example a metallic or concrete vat, in which case the doses of added tannin or tannins or the like are greater to take account of the zero addition from the material of the vat.

The process of the invention is equally applicable to the production of a red wine in a hermetic vat provided the same oxidative phenomena are created as those that take place in wooden barrels.

To this end, by supplementing the additions of tannin or tannins, there will be introduced into the liquid of the vat in a regular manner, continuously or stepwise in periodic doses, a certain quantity of oxygen for example on the average of the order of 0.5 to 5 mg/L and monthly, by various processes such as micro-bubbling, aeration, composition or mixture of products releasing oxygen.

In this case, for example, the quantity of ellagitanins to be added will be determined given that there are no ellagitanins diffused by the container and the value of the initial content will be about 100 mg/L. The quantities added in the course of time will be about 5 mg/L/month greater than those of the case shown in FIG. 2.

These increased doses correspond to those used in the case of used barrels.

The process of the invention can also be used to supplement for example tannins in brandies, the doses being substantially greater than for wine.

Thus, to produce a brandy of the type of VSOP cognac, the total quantity of tannin to be added will be about 1 g per degree of alcohol and per hectoliter.

This addition could take place by half at the beginning of production, then during production of a minimum of 12 months and preferably 18 months, an addition of 1/10 of the total pre-calculated dose, for the first time at the end of 4 months and then each two months. The The frequency of additions and adjustment of the doses could be modified as a function of taste.

When there is produced a brandy of the more ordinary type, one proceeds the same way but with smaller doses that can reach ⅓ of those set forth above.

In the case of brandies, either the production will take place in used casks or used barrels and the phenomena of provided oxidation will be carried out through the wood, or the production will take place in a hermetic vat and in the same manner as in the example given above with respect to wine and will involve recreating the same oxidative phenomena as those produced in a barrel by providing a quantity of oxygen on the order, on the average, of 0.5 to 5 mg/L per month by the process as described above, continuously or stepwise.

It is to be noted that the process of the invention can be practiced to supplement any alcoholic beverage (wine, brandy, beer, etc . . . ) with various constituents, tannins or the like, particularly in constituents naturally provided by the material of the production container of the alcoholic beverage when these constituents are not provided in a sufficient quantity, even when they are not provided at all as is the case of containers constituted by metallic or concrete vats, although it is desirable that the produced beverage contain such constituents.

1. Process for supplementing an alcoholic beverage with constituents, during its production, in which, while said beverage is in a production container, carrying out an addition to said beverage of said constituents, characterized in that said addition is carried out with a dosage of constituents predetermined as a function of the measured or estimated difference, of the content of said constituents, between a barrel of new wood of the best essence and said production container, and in that supplemental additions are carried out at predetermined intervals and with dosages predetermined as a function of the nature of said container, so as to compensate in the course of time the decrease by degradation of said constituents and to obtain a curve of concentration in constituents of said beverage resembling that which would be obtained with said barrel of the best essence in lieu and in place of said container.

2. Process according to claim 1, more particularly applied to the supplementation in tannins or the like of a wine during its production in a used wood barrel, characterized in that said initial addition is carried out with a dosage of tannins comprised between 50 and 80 mg/L, whilst the ultimate addition is of the order of 5 to 20 mg/L/month.

3. Process according to claim 2, characterized in that the second addition is carried out at about three or four months after the initial addition and the ultimate additions are spaced apart by one or two months.

4. Process according to claim 2 or 3, characterized in that the ultimate content is first of the order of 10 to 20 mg/L/month, then the order of 5 to 10 mg/L/month toward the end of production.

5. Process according to one of claims 2 to 4, characterized in that the tannins are constituted by one of the constituents of the group comprising ellagic tannins, proanthocyanidic tannins, gallic tannins or a mixture of some or all of these.

6. Process according to one of claims 2 to 5, characterized in that the additions of tannins are carried out in the form of a powder, granular material, or an effervescent tablet.

7. Process according to claim 1, more particularly applied to the supplementation in tannin or tannins or the like, of a wine during its production in a hermetic vat, characterized in that in addition to the various additions of tannin or tannins, there is introduced into the vat oxygen in a continuous or stepwise manner.

8. Process according to claim 7, characterized in that the quantity of oxygen is comprised on the average between 0.5 and 5 mg/L per month.

9. Process according to claim 7 or 8, characterized in that the oxygen is introduced by one of the processes of the group constituted by micro-bubbling, aeration, release from a compound or a mixture of products.

10. Process according to one of claims 7 to 9, characterized in that the initial addition is carried out with a dosage of the order of 100 mg/L, the ultimate quantity decreasing from 25 mg/L/month to 10 mg/L/month.

11. Process according to claim 1, more particularly applied to the supplementation in tannin or tannins of a brandy produced in a used barrel.

12. Process according to claim 1, more particularly applied to the supplementation in tannin or tannins of a brandy produced in a hermetic vat, oxygen being diffused in a suitable quantity into the liquid, continuously or stepwise.
